(19) United States
(12) Patent Application Publication
(10) Pub. No.: US 2021/0268434 A1
(43) Pub. Date: Sep. 2, 2021

(54) AN APPARATUS FOR CLEANING EXHAUST SMOKE

(71) Applicant: NANO SILVER MANUFACTURING SDN BHD, SHAH ALAM (MY)

(72) Inventor: CHEE SENG TEE, SHAH ALAM (MY)

(73) Assignee: NANO SILVER MANUFACTURING SDN BHD, SHAH ALAM (MY)

(21) Appl. No.: 16/967,614

(22) PCT Filed: Dec. 14, 2018
(86) PCT No.: PCT/MY2018/050091

§ 371 Date: Aug. 5, 2020

(30) Foreign Application Priority Data
Feb. 9, 2018 (MY) PI 2018700528

(51) Int. Cl. B01D 53/78; B01D 47/02; F23J 15/04

(52) U.S. Cl. CPC B01D 53/78; B01D 47/025; F23J 2219/40; F23J 2217/10; F23J 15/04

(57) ABSTRACT

The present invention discloses an apparatus (100), for scrubbing smoke comprising: a first tank (110), having a compartment (111), filled with a liquid; and, an inlet (112), configured to draw in the smoke into the compartment (111) from a combustion source, characterized in that, the first tank (110) includes a propeller system (113), arranged within the compartment (111) to mix the smoke with the liquid, for providing first scrubbing effect by propelling the liquid.

### FIELD OF INVENTION

The present invention relates to a cleaning apparatus. More particularly, the invention relates to an apparatus to clean or reduce pollutants in the smoke emitted from combustion.

### BACKGROUND OF THE INVENTION

Air pollution causes seriously impact people's health and the environment. The fumes and exhausts coming from municipal incinerators, coal burning power stations and many chemical and metallurgical processing plants are major sources of the air pollution. This is because of incomplete combustion, fly ash and other solids, ammonia, cyanogen, hydrogen sulphide and the acid oxides of sulphur and nitrogen.

These gases also cause significant problems with their distinctive odors and leads to major health hazards causing such problems as eye irritation and respiratory illness and seriously aggravating cardiovascular illness.

Further, the acid oxides on being hydrated by natural moisture, form an acid rain which is quite corrosive to many unprotected metals and marble stone structures. The solid particles in addition to causing major cleaning problems in many urban areas have been known to act as cloud seeds causing unexpected or excessive amounts of rain or snow to precipitate in regions downstream from the stack. As a result of all this, there has been a significant effort made to greatly reduce, if not eliminate, all solid and soluble gas contamination in these exhausts.

Therefore, the present invention provides a portable apparatus that can be easily transported and arranged to any kind of combustion sources to treat the smoke emitted from it so that level of pollutants in the smoke can be reduced to the greater extent and release clean air into atmosphere.

### SUMMARY OF INVENTION

The present invention provides an apparatus, for scrubbing smoke comprising: a first tank, having: a compartment, filled with a liquid; and, an inlet, configured to draw in the smoke into the compartment from a combustion source, characterized in that, the first tank includes a propeller system, arranged within the compartment for providing first scrubbing effect by mixing the smoke with the liquid.

Preferably, the smoke is pre-treated with a scrubbing liquid in a wet scrubber tank, arranged between the combustion engine and the first tank.

Preferably, the propeller system is configured to rotate at a pre-determined speed for mixing the smoke and water in the compartment.

Preferably, the compartment is partially filled with the liquid up to a pre-determined level.

Preferably, scrubbed liquid from the compartment is directed to the inlet to spray the liquid on the smoke entering through the inlet.

Preferably, the first tank further includes at least one filter arranged in between the compartment and the inlet to filter out the pollutants from the scrubbed liquid circulating between the compartment and the inlet.

Preferably, the filter is an alkaline filter system.

Preferably, the first tank further includes a drainage outlet to drain out the liquid from it at pre-set time period.

Preferably, the first tank further includes an auto refill inlet to refill the liquid automatically at pre-set time period.

Preferably, the smoke is directed to flow through a patterned flow path arranged in the compartment prior to mixing the smoke with the liquid.

One skilled in the art/grounding systems will readily appreciate that the invention is well adapted to carry out the grounding installation and obtain the advantages mentioned, as well as those inherent therein. The embodiments described herein are not intended as limitations on the scope of the invention.

### BRIEF DESCRIPTION OF THE DRAWINGS

For the purpose of facilitating an understanding of the invention, there is illustrated in the accompanying drawing the preferred embodiments from an inspection of which when considered in connection with the following description, the invention, its construction and operation and many of its advantages would be readily understood and appreciated.

FIG. 1 is schematic diagram illustrating the smoke scrubbing apparatus in accordance to present invention.

FIG. 2 is schematic diagram illustrating the smoke scrubbing apparatus arranged with a combustion source in accordance to present invention.

### DETAILED DESCRIPTION OF THE INVENTION

The invention will now be described in greater detail, by way of example, with reference to the drawings.

The present invention provides an apparatus (100) for scrubbing a smoke which can be a white smoke or blue smoke or black smoke.

The white smoke results from water mixing with the exhaust gases or combustion cycle.

The blue smoke results from oil mixing with the exhaust gases or combustion cycle.

The black smoke results from an abundance of fuel in the combustion cycle.

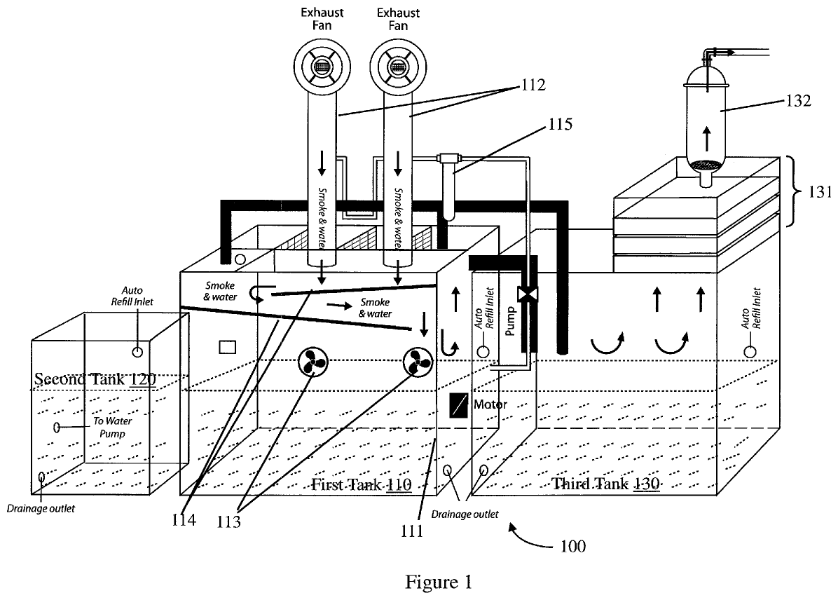

Referring to the FIG. 1, illustrates a portable apparatus (100) to scrub smoke from combustion sources comprises of a first tank (110), a second tank (120) and a third tank (130). The smoke emitted from the combustion source is drawn in to the first tank (110) for providing first scrubbing effect.

The first tank (110) comprises of a compartment (111), an inlet (112), a propeller system (113), a patterned passage path flow (114), and a filter (115). The compartment (111) can be filled with a liquid fully or up to a pre-determined level. The liquid can be a water or a scrubbing liquid. The inlet (112) can be an elongated tower arranged above the compartment (111) which includes an exhaust fan arranged on one end of the tower to draw in the smoke and a liquid sprayer arranged inside the tower to spray the liquid on the smoke entering into the compartment (111) through the inlet (112). The patterned passage flow path (114) formed using a pair of plates of sheets arranged in form of a serpentine is arranged in the compartment (111) above the liquid level. The smoke and the water is directed to flow through the serpentine passage flow path such that the scrubbing liquid can be precipitated from the smoke to run down the flow path and into the liquid. The smoke is also precipitated while mixing with the liquid. The propeller system (113) is arranged in the compartment (111) filled with the liquid includes at least one propeller and a motor to power the propeller. The propeller system (113), rotates at a pre-determined speed in the liquid to ensure the smoke entering the compartment (111) is brought in to contact with the liquid to provide first scrubbing effect such that the pollutants, dirt in the smoke are scrubbed from it. This first scrubbing effect makes the smoke lighter and cleaner air. The liquid from the compartment (111) is directed to the inlet (112) via a pipe connecting the compartment (111) and elongated inlet (112) for reuse the liquid. The first tank (110) further includes a pump, arranged to pump the liquid from the compartment (111) to the inlet (112) via the filter (115) which is arranged to filter and cleanse the liquid from dirt in order reuse and spray clean liquid in the inlet (112). The filter (115) is arranged can be an alkaline filter system or any other filter system used. The compartment (111) further includes a drainage outlet and a refill inlet. The liquid in the first tank (110) becomes dirty over a period of time and the liquid can be changed automatically with clean liquid preferably at pre-set time interval. Where the dirty liquid can be drained out from the first tank (110) through the drainage outlet and fresh liquid is refilled in the first tank (110) through the auto refill inlet. The compartment (111) is divided into two sub compartments, first sub compartment and second sub compartment. In first sub compartment includes the passage flow path arranged in it. In second sub compartment includes a plurality of filters arranged where the smoke circulating in the first sub compartment is directed to flow through these filter layers and back to first sub compartment.

The second tank (120) is an auto refill tank comprises a liquid pump for the liquid supply and the drainage outlet to drain out the liquid from it. The second tank (120) supplies the liquid to the first tank (110) and the third tank (130) automatically and preferably at a pre-determined time interval such that the pre-determined liquid level is maintained in the first tank (110) and in the third tank (130).

The third tank (130) includes a refill inlet, a drainage outlet, a carbon filter layer (131) and a filter bag (132). The carbon filter layer (131) and the filter bag (132) are arranged on the top of the third tank (130). The treated smoke in the first tank (110) is directed through a branch pipe to flow into the third tank (130). In the third tank (130) is filled with the liquid fully or up to a pre-determined level. The first tank (110) and the third tank (130) are connected by the branch pipe whose one end is arranged in the first tank (110) to receive the treated smoke and the other end is arranged above the liquid level in the third tank (130). Where the treated smoke from the first tank (110) is directed to the third tank (130) via the branch pipe for further treatment for providing second scrubbing effect in the third tank (130). The treated smoke is retained in the third tank (130), due to pressure the heavier dust particles and/or the water droplets in the treated smoke settles down into the third tank (130). The liquid in the third tank (130) becomes dirty over a period of time and the liquid can be changed automatically with clean liquid preferably at pre-set time interval. Where the dirty liquid can be drained out from the third tank (130) through the drainage outlet and fresh liquid is refilled in the third tank (130) through the refill inlet. Further, the smoke is directed through the layers of the carbon filter (131) where the smoke is deodorized. Preferably three layers of the carbon is arranged in the carbon filter (131). Furthermore, the smoke is treated through the filter bag (132) and the clean air is released out from the outlet. The smoke is completely neutralized or scrubbed in the third tank (130) and the clean air is released out from the third tank (130).

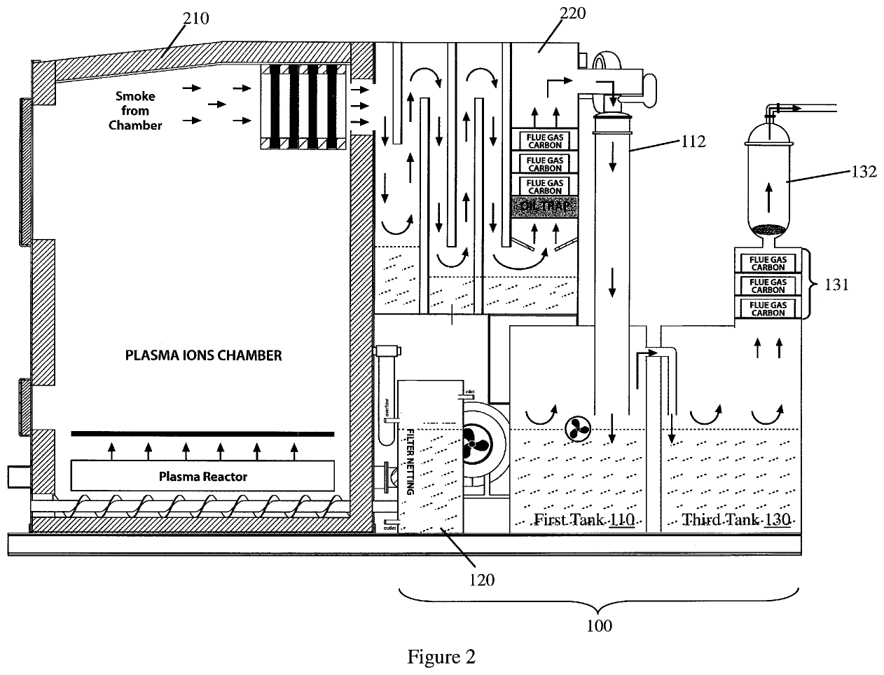

Referring to the FIG. 2, the smoke scrubbing apparatus (100) is portable and can be connected to any kind of the combustion source to form a unitary unit. The whole unit includes the combustion source (210), wet scrubber tank (220) and the smoke scrubbing apparatus (100). The combustion source can be any kind of source example plasma ions chamber. The industrial waste can be dumped into combustion chamber and is burnt at high temperature. The smoke from the combustion source can be pre-treated with a scrubbing solution in the wet scrubber tank (220) which can be arranged in between the combustion source and the first tank (110) as shown in the FIG. 2. The treated smoke is sent to the smoke scrubbing apparatus (100) for scrubbing the pollutants in the smoke.

The present disclosure includes as contained in the appended claims, as well as that of the foregoing description. Although this invention has been described in its preferred form with a degree of particularity, it is understood that the present disclosure of the preferred form has been made only by way of example and that numerous changes in the details of construction and the combination and arrangements of parts may be resorted to without departing from the scope of the invention.

1.-10. (canceled)

11. An apparatus, for scrubbing smoke comprising:
a tank, including:
a compartment filled with a liquid;
an inlet configured to draw in the smoke into the compartment from a combustion source; and
a propeller system arranged within the compartment for providing a scrubbing effect by mixing the smoke with the liquid.

12. The apparatus according to claim 11, wherein the smoke is pre-treated with a scrubbing liquid in a wet scrubber tank arranged between the combustion engine and the tank.

13. The apparatus according to claim 11, wherein the propeller system is configured to rotate at a pre-determined speed for mixing the smoke and water in the compartment.

14. The apparatus according to claim 11, wherein the compartment is partially filled with the liquid up to a pre-determined level.

15. The apparatus according to claim 11, wherein scrubbed liquid from the compartment is directed to the inlet to spray the liquid on the smoke entering through the inlet.

16. The apparatus according to claim 15, wherein the tank further includes at least one filter arranged in between the compartment and the inlet to filter out the pollutants from the scrubbed liquid circulating between the compartment and the inlet.

17. The apparatus according to claim 16, wherein the filter is an alkaline filter system.

18. The apparatus according to claim 11, wherein the tank further includes a drainage outlet to drain out the liquid from it at a pre-set time period.

19. The apparatus according to claim 11, wherein the tank further includes an auto refill inlet to refill the liquid automatically at a pre-set time period.

20. The apparatus according to claim 11, wherein the smoke is directed to flow through a patterned flow path arranged in the compartment prior to mixing the smoke with the liquid.
